(19) United States
(12) Patent Application Publication
(10) Pub. No.: US 2015/0134687 A1
(43) Pub. Date: May 14, 2015

(54) SYSTEM AND METHOD OF SHARING PROFILE IMAGE CARD FOR COMMUNICATION

(71) Applicant: SAMSUNG ELECTRONICS CO., LTD., Suwon-si (KR)

(72) Inventors: Jung-joo SOHN, Seoul (KR); Keum-koo LEE, Yongin-si (KR); Hye-won LEE, Anyang-si (KR); Chul-ho HAN, Seoul (KR); Yong-gook PARK, Yongin-si (KR)

(73) Assignee: SAMSUNG ELECTRONICS CO., LTD., Suwon-si (KR)

(21) Appl. No.: 14/534,965

(22) Filed: Nov. 6, 2014

(30) Foreign Application Priority Data
Nov. 13, 2013 (KR) 10-2013-0137890

(51) Int. Cl. G06F 17/30; H04L 29/06

(52) U.S. Cl. CPC G06F 17/30386; H04L 65/403
USPC 707/758

(57) ABSTRACT

A system and a method of sharing a profile image card of a user are provided. The method may be performed by a first device and includes obtaining a plurality of profile image cards of a first user of the first device; matching at least one profile image card of the first user from among the plurality of profile image cards with a second user of a second device; extracting link information about the at least one matched profile image card; and requesting to communicate with the second device and transmitting the link information about the at least one matched profile image card to the second device.

### CROSS-REFERENCE TO RELATED APPLICATION(S)

This application claims priority from Korean Patent Application No. 10-2013-0137890, filed on Nov. 13, 2013 in the Korean Intellectual Property Office, the disclosure of which is incorporated herein in its entirety by reference.

### BACKGROUND

1. Field

Apparatuses and methods consistent with exemplary embodiments relate to a system and method for sharing a profile image card of a user during communication between devices.

2. Description of Related Art

Due to developments in multimedia and network technologies, the number of users that use social network services (SNS) has increased. Social networking sites allow users to share ideas, activities, events, and interests within their individual networks. Most social network services are web based and provide a means for users to interact in various ways, such as through e-mail and instant messaging.

Features of social networking sites include the ability to construct a personal profile which can be shared with others, and compile a list of users to share information with, on most sites called a fiends list. Some sites allow for photo uploads, blog entries, people search, and adding applications such as games and multimedia. Also, when users communicate with one another via the SNS, the users may present themselves by using various types of data from the personal profile.

For example, a user may introduce himself/herself to other users using different types of content according to various circumstances. In this regard, an amount, level, and type of information that the user shares may differ according to various circumstances of the user and various circumstances of the site being used.

Thus, there is a need for a technique that is capable of efficiently distinguishing between various types of user profile information, providing of the user profile information, and sharing of the user profile information among devices by efficiently using an application of the devices during communication therebetween.

### SUMMARY

Exemplary embodiments overcome the above disadvantages and other disadvantages not described above. Also, an exemplary embodiment is not required to overcome the disadvantages described above, and an exemplary embodiment may not overcome any of the problems described above.

One or more exemplary embodiments provide a profile image card sharing system and a method therefor capable of efficiently sharing a profile image card of a user with another user during communication between devices.

According to an aspect of an exemplary embodiment, there is provided a method of a first device for sharing a profile image card, the method including obtaining a plurality of profile image cards of a first user of the first device; matching at least one profile image card of the first user from among the plurality of profile image cards with a second user of a second device; extracting link information about the at least one matched profile image card; and requesting to communicate with the second device and transmitting the link information about the at least one matched profile image card to the second device.

The link information may interoperate with a communication application that is executed by the second device, and the at least one matched profile image card of the first user may be displayed on a screen of the second device via the communication application.

The link information may be pushed to the second device in response to the first device beginning communication with the second device.

The at least one profile image card of the first user may be matched with the second user based on at least one of a user group of the second user and a relationship between the first user and the second user.

The at least one profile image card of the first user may be matched with the second user based on user information stored in a phone book of the first device.

The at least one profile image card of the first user may be matched with the second user based on relationship information of the first user on a social network service (SNS).

The extracting may include extracting the link information based on at least one of an identification (ID) value of the second device, a type of an operating system (OS) of the second device, a type of communication application executed by the second device, and a performance of the second device.

The link information may include a link address for downloading data of the at least one matched profile image card of the first user.

When the at least one matched profile image card of the first user is changed, the method may further include pushing link information of a changed matched profile image card of the first user to the second device of the second user.

The at least one matched profile image card of the first user may be downloaded to the second device via another network that is different from a network for the communication.

The communication may include at least one of a phone communication and a message communication.

The plurality of profile image cards of the first user may be generated by the first user according to a plurality of categories.

The matching may further include providing a list of the plurality of profile image cards of the first user to the second device of the second user; receiving, from the second device, an ID value of a profile image card of the first user that is selected from the list by the second user; and matching the profile image card of the first user having the ID value with the second user.

According to an aspect of another exemplary embodiment, there is provided a first device that shares a profile image card of a first user, the first device including a controller configured to obtain a plurality of profile image cards of the first user of the first device, match at least one profile image card of the first user from among the plurality of profile image cards with a second user, and extract link information about the at least one matched profile image card of the first user; and a communicator configured to request to communicate with the second device of the second user, and transmit the link information about the at least one matched profile image card to the second device.

The link information may interoperate with a communication application that is executed by the second device, and the matched at least one profile image card of the first user may be displayed on a screen of the second device via the communication application.

The controller may push the link information to the second device in response to the first device beginning communication with the second device.

The controller may match the at least one profile image card of the first user with the second user based on at least one of a user group of the second user and a relationship between the first user and the second user.

The controller may match the at least one profile image card of the first user with the second user based on user information stored in a phone book of the first device.

The controller may match the at least one profile image card of the first user with the second user based on relationship information of the first user on a social network service (SNS).

The controller may extract the link information based on at least one of an identification (ID) value of the second device, a type of an operating system (OS) of the second device, a type of communication application executed by the second device, and a performance of the second device.

The link information may include a link address for downloading data of the at least one matched profile image card of the first user.

When the at least one matched profile image card is changed, the controller may push link information of a changed matched profile image card of the first user to the second device of the second user.

The at least one matched profile image card of the first user may be downloaded to the second device via another network that is different from a network for the communication.

The communication may include at least one of a phone communication and a message communication.

The plurality of profile image cards of the first user may be generated by the first user according to a plurality of categories.

The controller may provide a list of the plurality of profile image cards of the first user to the second device of the second user, may receive from the second device an ID value of a profile image card of the first user that is selected from the list by the second user, and may match the profile image card of the first user having the ID value with the second user

According to an aspect of another exemplary embodiment, there is provided a method of a second device for obtaining a profile image card, the method including receiving, from a first device, a request for communication and link information of a profile image card of a first user of the first device; displaying, in response to the request, the link information using a communication application; downloading data of the profile image card of the first user from a server based on a user input with respect to the link information; and displaying the profile image card of the first user on an execution screen corresponding to the communication application.

According to aspects of other exemplary embodiments, there is provided a non-transitory computer-readable medium having recorded thereon a program that is executable by a computer to perform the methods described herein.

### BRIEF DESCRIPTION OF THE DRAWINGS

The and/or other aspects will become apparent and more readily appreciated from the following description of the embodiments, taken in conjunction with the accompanying drawings in which:

FIG. 1 is a diagram illustrating a profile image card sharing system according to an exemplary embodiment;

FIG. 2 is a diagram illustrating an example of a profile image card, according to an exemplary embodiment;

FIGS. 3A through 3C are diagrams illustrating information linked to a stamp image in a profile image card, according to exemplary embodiments;

FIGS. 4A and 4B are diagrams illustrating a plurality of profile image cards, according to exemplary embodiments;

FIG. 5 is a flowchart illustrating a method of a first device providing a profile image card to a second device, according to an exemplary embodiment;

FIG. 6 is a flowchart illustrating a method of sharing a profile image card in a profile image sharing system, according to an exemplary embodiment;

FIG. 7 is a flowchart illustrating a method of a first device for generating a profile image card, according to an exemplary embodiment;

FIG. 8 is a flowchart illustrating a method of a first device for matching a profile image card of a first user with a second user, according to an exemplary embodiment;

FIG. 9 is a flowchart illustrating a method of a first device for matching a profile image card of a user with a second user in consideration of an idea of the second user, according to an exemplary embodiment;

FIG. 10 is a flowchart illustrating a method of a first device for extracting link information of a profile image card, according to an exemplary embodiment;

FIG. 11 is a diagram illustrating a user of a first device selecting one of his/her profile image cards from a screen for making a call, according to an exemplary embodiment;

FIG. 12 is a diagram illustrating a user of a second device selecting a profile image card of a first user, according to an exemplary embodiment;

FIG. 13 is a diagram illustrating a second device receiving update information about a profile image card of a first user, according to an exemplary embodiment;

FIG. 14 is a diagram illustrating a profile image card that is displayed in a contact list of a second device, according to an exemplary embodiment;

FIG. 15 is a diagram illustrating a profile image card that is displayed on an execution screen of a messaging application of a second device, according to an exemplary embodiment;

FIGS. 16A through 16C are diagrams illustrating a first device calling a second device, according to exemplary embodiments;

FIGS. 17A and 17B are diagrams illustrating a stamp image that is applied to a profile image card, according to exemplary embodiments;

FIG. 18 is a diagram illustrating a stamp image, according to an exemplary embodiment;

FIGS. 19 and 20 are block diagrams of a first device, according to exemplary embodiments; and

FIG. 21 is a block diagram of a server, according to an exemplary embodiment.

### DETAILED DESCRIPTION

Hereinafter, the exemplary embodiments are described with reference to the accompanying drawings. However, the exemplary embodiments may be embodied in many different forms and should not be construed as being limited to the embodiments set forth herein. Rather, these embodiments are provided so that this disclosure will be thorough and complete, and will fully convey the concept of the embodiments to those of ordinary skill in the art. In the following description, well-known functions or constructions will not be described in detail so as not to obscure the exemplary embodiments with unnecessary detail. Also, throughout the specification, like reference numerals in the drawings denote like elements.

As described herein, it will be understood that when an element is referred to as being “connected to” another element, it can be directly connected to the other element, or electrically connected to the other element while intervening elements are present.

As described herein, the term “profile image card” indicates an image card that includes a profile of a user of a device. For example, a profile image card may include information indicating a field of interest of the user of the device. Also, the profile image card may include at least one image that indicates the profile of the user.

The profile image card may be embodied in various forms. For example, the profile image card may include a post card, a name card, an invitation card, a gift card, and the like.

As described herein, a stamp image may be a user interface (UI) that includes information that a user wants to provide to another user. The stamp image may be applied to the profile image card or may be included in the profile image card. For example, the stamp image may be an icon including at least one of a text, an image, a figure, a photo, a video, and the like. The stamp image may also include information about a user such as mood, interests, profile, location, and the like. The stamp image may also include a link address for using a user service, a discount coupon, and the like. Also, in various examples, the stamp image may include, but is not limited to, information that indicates an expertise area of the user in the profile image card.

As described herein, the term “content” may refer to digital information that is provided via a wired or wireless communication network. For example, the content may include, but is not limited to, motion picture content such as a video-on-demand (VOD) TV program video, a personal video such as User-Created Contents (UCC), a music video, a YouTube video, and the like. The content may also include still image content such as a photo, a picture, and the like, music content such as music, radio broadcasting, and the like, a web page, application execution information, and the like.

As described herein, the term “application” may be used to refer to a group of computer programs that are designed to perform a particular task. The application described in the present application may vary. For example, the application may include, a book application, a game application, a video reproducing application, a map application, a memo application, a calendar application, a broadcasting application, an exercise support application, a payment application, a photo folder application, and the like.

As described herein, communication may be performed using a phone communication service, a text message exchange service using a service of a communication business provider, a message exchange service via a social network service (SNS) server, and the like.

A user input may include, but is not limited to, a touch input, a bending input, a voice input, a key input, a multimodal input, and the like. The touch input indicates a gesture of the user which is performed on a touch screen to control a device. For example, the touch input may include a tap gesture, a touch and hold gesture, a double tap gesture, a drag gesture, a panning gesture, a flick gesture, a drag and drop gesture, and the like. The motion input indicates a motion that a user performs to control the device. For example, the motion input may include an input of the user rotating the device, tilting the device, moving the device in an up, down, right, and left directions, and the like.

The bending input may be performed by a user who bends a whole or partial area of the device so as to control the device. In this example, the device may be a flexible display device. The key input indicates an input of a user who controls the device using a physical key formed on the device or that is displayed as a virtual keyboard on a display of the device. The multimodal input refers to a combination of at least two input methods. For example, the device may receive a touch input and a motion input of the user, a touch input and a voice input of the user, and the like. As another example, the device may receive a touch input and an eye input of the user. The eye input may refer to an example in which the user adjusts a blinking motion of his or her eye, a gaze position, a moving speed of his or her eye, and the like, so as to control the device.

Throughout the specification, for convenience of description, a user of a first device is referred to as a first user and a user of a second device is referred to as a second user.

When a first device pushes data, for example, link information to a second device may refer to the first device transmitting the data to the second device, without a separate request from the second device. Also, the pushed data may be displayed on a screen of the second device without a user input by a user of the second device.

As used herein, the term “and/or” includes any and all combinations of one or more of the associated listed items. Expressions such as “at least one of,” when preceding a list of elements, may modify the entire list of elements or may not modify the individual elements of the list.

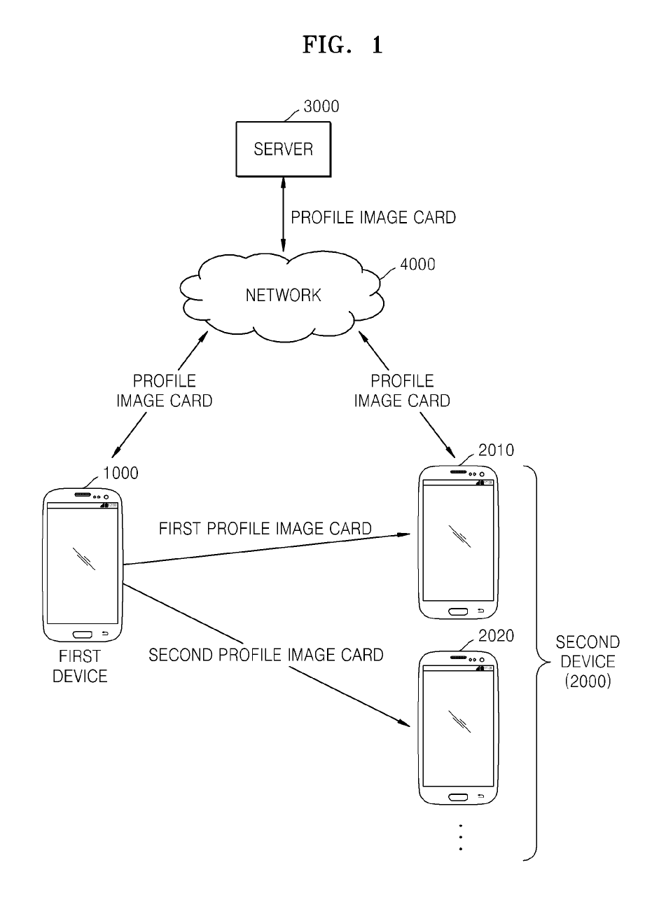

FIG. 1 is a diagram illustrating a profile image card sharing system according to an exemplary embodiment.

As illustrated in FIG. 1, the profile image card sharing system includes a first device 1000, at least one second device 2000, a server 3000, and a network 4000.

The first device 1000 may generate a profile image card of a first user of the first device 1000, and provide the generated profile image card to the second device 2000. The first device 1000 may also generate a plurality of profile image cards of the first user according to several categories. For example, if the first user is a medical doctor that likes to go climbing and play soccer, the first device 1000 may generate a profile image card including user profile information about one or more of his job as a medical doctor, a profile image card including user profile information about his hobby to go climbing, and a profile image card including user profile information about his hobby to play soccer, based on a user input. Also, the first device 1000 may register the profile image cards of the first user in the first device 1000 and/or the server 3000.

The first device 1000 may match the profile image card of the first user with a second user of the second device 2000. For example, the first device 1000 may match the profile image card with the second user, in consideration of a relationship between the first user and the second user. The matching may include matching a profile image card of the first user with an identification (ID) value of the second user or matching the profile image card of the first user with a user group of the second users. However, the exemplary embodiments are not limited thereto.

When the first device 1000 starts communication with the second device 2000, the first device 1000 may provide link information about the profile image card of the first user that is matched with the second user to the second device 2000. For example, the link information may include a link address for downloading data of the profile image card of the first user.

The profile image card may interoperate with a communication application that is executed by the second device 2000. Also, when the first device 1000 and the second device 2000 are communicating, the profile image card of the first user may be displayed on a screen of the second device 2000 via the communication application that is executed by the second device 2000.

For example, the first device 1000 and the second device 2000 may be, but are not limited to, a smart phone, a smart television (TV), a mobile phone, a tablet, a personal digital assistant (PDA), a laptop computer, a media player, a micro-server, a global positioning system (GPS) device, an electronic book terminal, a terminal for digital broadcasting, a navigation device, a kiosk, an MP3 player, a digital camera, an appliance, and other mobile or non-mobile computing devices.

The server 3000 receives the profile image card of the first user from the first device 1000 and registers the profile image card of the first user. The server 3000 may store content that is included in or that is linked to the profile image card of the first user. In response to a request from the second device 2000, the server 3000 may provide a profile image card of the first user and content that is linked to the profile image card of the first user to the second device 2000. The server 3000 may also store matching information about the profile image card of the first user. For example, the matching information may indicate which user or which user group is matched with the profile image card of the first user.

The network 4000 connecting the server 3000 and the devices 1000 and 2000 may include one or more of a Local Area Network (LAN), a Wide Area Network (WAN), a Value Added Network (VAN), a mobile radio communication network, a satellite communication network, and the like. Also, the network 4000 may indicate a general-concept data communication network that is capable of allowing network parties shown in FIG. 1 to perform communication with one another and may include a wired Internet, a wireless Internet, a mobile wireless communication network, and the like.

In the profile image card sharing system, the first device 1000 and the second device 200 may share a profile image card of the first user via the server 3000, but one or more of the exemplary embodiments are not limited thereto. For example, the first device 1000 may directly share the profile image card of the first user with the second device 200.

Also, for convenience of description, the first device 1000 generates the profile image card of the first user, and the second device 2000 receives the profile image card of the first user, but the exemplary embodiments are not limited thereto. As another example, the second device 2000 may generate a profile image card of the second user, and the first device 1000 may receive the profile image card of the second user from the second device 2000.

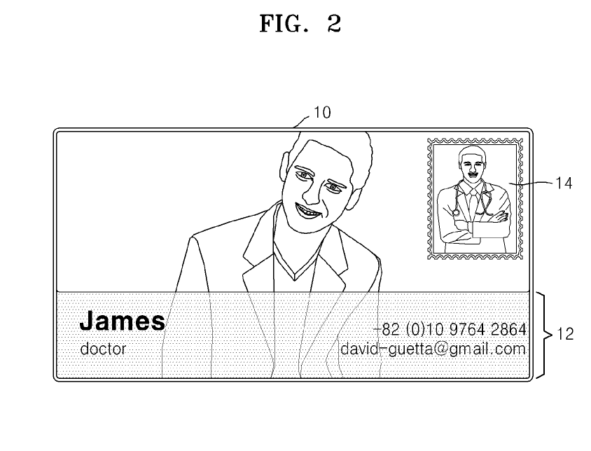

FIG. 2 is a diagram illustrating a profile image card of a first user, according to an exemplary embodiment.

Referring to FIG. 2, the profile image card of the first user includes content 10, a text 12, and a stamp image 14. For example, the content 10 may include an image, a video, music, and the like, by which the first user expresses an interest. Also, the content 10 may include, but is not limited to, a photo that indicates a job of the first user, a webpage of the first user, a map image that indicates a location of the first user, and the like.

The text 12 may be letters by which the first user expresses an interest. The text 12 may include, but is not limited to, a name, a job, a field of interest, a telephone number, an e-mail address, and various comments from the first user.

The stamp image 14 may be a UI object including additional information that the first user wants to provide to other users, and may be applied to the profile image card or may be included in the profile image card. For example, the stamp image 14 may be an icon that includes at least one selected from a letter, an image, a figure, and the like. The stamp image 14 may also include, but is not limited to, a plurality of pieces of information about a first user such as a mood, a field of interest, a user profile, a location, a link address for using a service of the first user, and the like. The stamp image 14 may include, but is not limited to, information that indicates an area of expertise of the first user in the profile image card.

As another example, a tag that indicates a category of the profile image card of the first user may be attached to the stamp image 14. The tag attached to the stamp image 14 may be used by the server 3000 and the first device 1000 to identify a category of the profile image card of the first user.

The profile image card may be displayed as caller identification information on a receiving terminal during a phone conversation. As another example, the profile image card may be displayed in a user list of a phone book, or may be used as a signature in an e-mail. As another non-limiting example, the profile image card may be displayed on a lock screen or a home screen of the first device 1000.

The profile image card of the first user may interoperate with a native application and a downloaded application of the first device 1000, and may be shared with another device in various manners using various applications. As another example, the profile image card of the first user may interoperate with a web service that is provided via a network.

In some examples, a profile image card may be used to indicate a job or to express a mood of a person, but the exemplary embodiments are not limited thereto. For example, the profile image card may be used by a company for promotional activities, product advertisement, to provide a coupon, and the like.

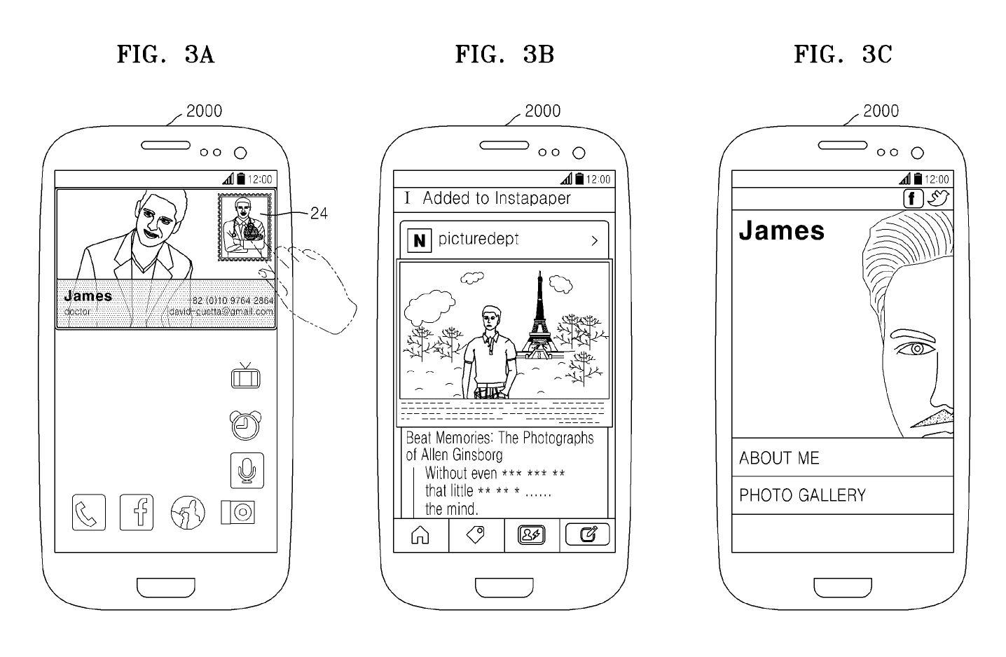

FIGS. 3A through 3C illustrate information that is linked to a stamp image 24 that is included in a profile image card, according to an exemplary embodiment.

Referring to FIG. 3A, a second user may select the stamp image 24 that is included in a profile image card of a first user while it is displayed on a screen of the second device 2000. In response, as illustrated in FIG. 3B, a blog of the first user that is linked to the stamp image 24 may be displayed on the screen of the second device 2000. As another example, when the stamp image 24 is selected as illustrated in FIG. 3C, a webpage of the first user that is linked to the stamp image 24 may be displayed on the screen of the second device 2000. However, the exemplary embodiments are not limited thereto. For example, when the stamp image 24 is selected, the second device 2000 may access an SNS account of the first user that is linked to the stamp image 24.

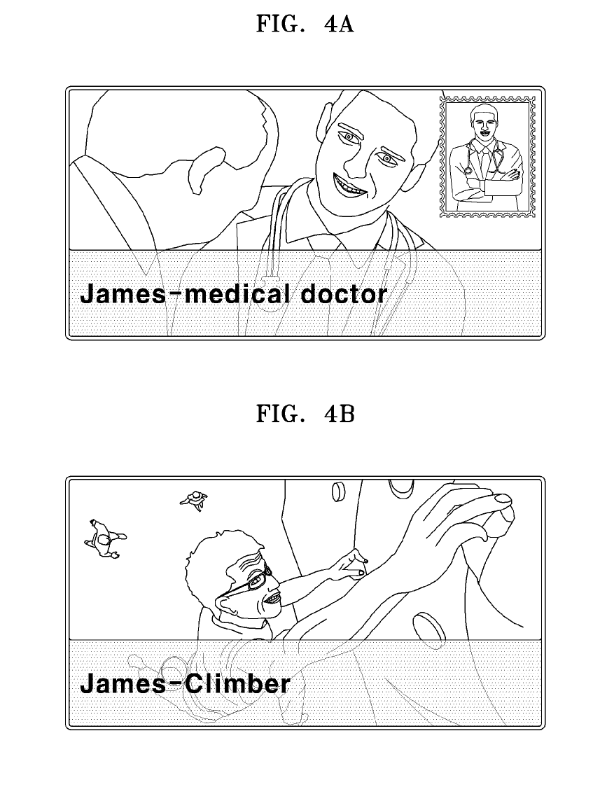

FIGS. 4A and 4B illustrate a plurality of profile image cards of a first user, according to an exemplary embodiment. A first user may generate the plurality of profile image cards as a way to introduce himself/herself similar to a business card.

Referring to FIG. 4A, James, who in this example is the first user, is a medical doctor. Accordingly, James may generate his profile image card including a profile of himself as the doctor. James may also have a hobby of climbing. Referring to FIG. 4B, James may generate a profile image card including a profile indicating James is a climber.

The first user may match the profile image card of FIG. 4A and the profile image card of FIG. 4B with different users. For example, the first user may match the profile image card of FIG. 4A with users A, B, and C, and may match the profile image card of FIG. 4B with users D, E, and F. The first user may also match the profile image card of FIG. 4A and the profile image card of FIG. 4B with a group of users or with different user groups. For example, the first user may match the profile image card of FIG. 4A with user groups G and H, and match the profile image card of FIG. 4B with a user group I.

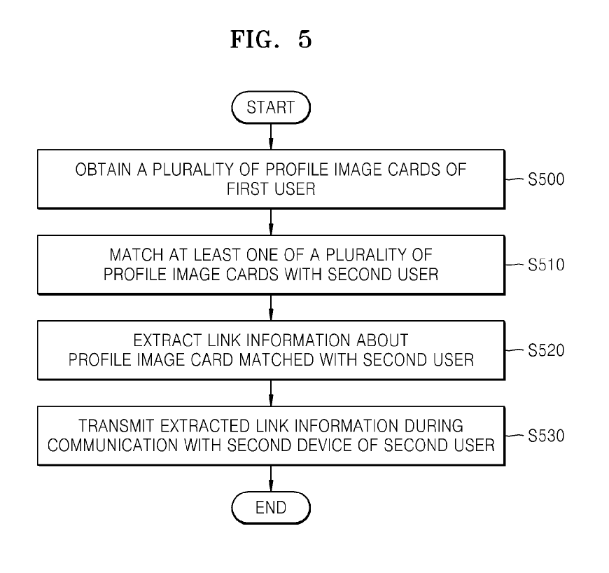

FIG. 5 is a flowchart illustrating a method of a first device providing a profile image card to the second device 2000, according to an exemplary embodiment.

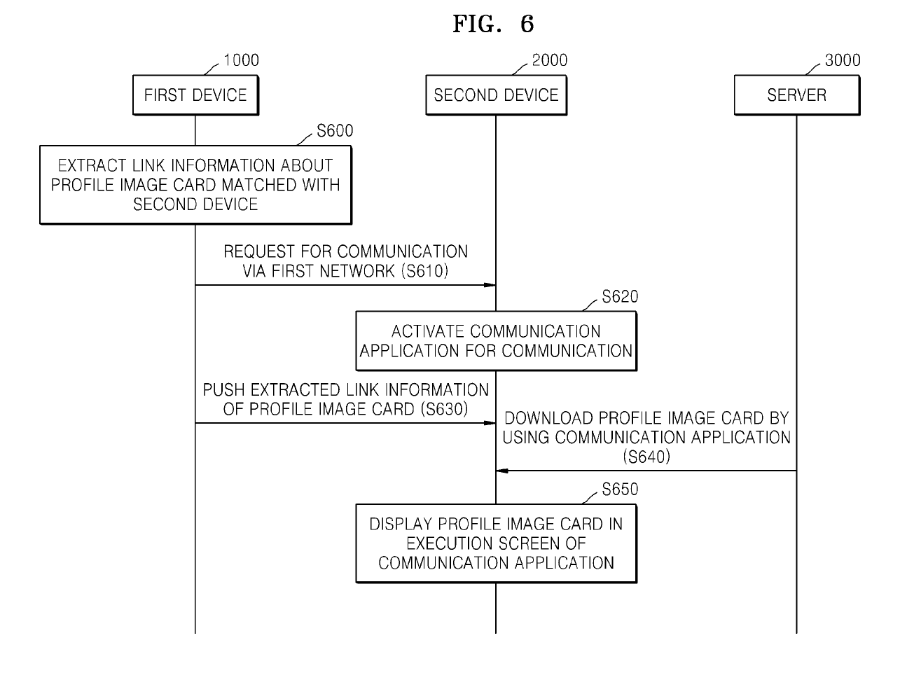

Referring to FIG. 5, in operation S500, the first device 1000 obtains a plurality of image cards of a first user. For example, the first device 1000 may obtain the image cards of the first user from a memory such as memory 1700 shown in FIG. 20. As another example, the first device 1000 may obtain the image cards of the first user from a server such as server 3000 shown in FIG. 6. In this case, the image cards may be previously stored in the memory 1700 or the server 3000.

The first device 1000 may generate a profile image card of the first user. For example, the first device 1000 may generate the profile image card via a user interface that is provided by an application that is executed by the first device 1000. The application that is executed by the first device 1000 may be a native application of the first device 1000, but the exemplary embodiments are not limited thereto. As another example, the first device 1000 may generate the profile image card via a user interface that is provided by the server 3000.

In operation S510, the first device 1000 matches at least one profile image card from among a plurality of profile image cards of the first user with a second user. For example, the first device 1000 may match the profile image card of the first user with the second user based on user information, group information, relationship information about the second user, and the like. The first device 1000 may identify a user group of the second user, and may match the second user with a profile image card of the first user that is included in the same user group as the second user. In this example, profile image cards may be previously matched with user groups, respectively. As another example, the first device 1000 may obtain an SNS ID of the first user and an SNS ID of the second user, and may recognize or otherwise determine a relationship between the first user and the second user based on the obtained SNS IDs of the first and second users. The first device 1000 may match a profile image card of the first user with the second user based on the determined relationship between the first user and the second user.

The first device 1000 may match a profile image card of the first user with the second user based on a user input. For example, user information, group information, relationship information, and the like, about the second user may be displayed on a screen of the first device 1000, and the first user may select one of his profile image cards from a profile image card list. For example, the first user may select the second user from a phone book to call the second user device 2000. In response, the user information, the group information, and the relationship information about the second user may be displayed on a screen of the first device 1000. Alternatively, the first user may select at least one profile image card from among the profile image cards and the first device 1000 may start communication with the second device 2000.

In operation S520, the first device 1000 extracts link information about the profile image card of the first user that is matched with the second user. For example, the link information about the profile image card of the first user may include a link address for downloading data of the profile image card of the first user. The first device 1000 may extract the link information based on an attribute of the second device 2000 and an attribute of a communication application that are installed in the second device 2000. For example, the first device 1000 may check an ID value of the second device 2000, a type of operating system (OS) of the second device 2000, performance of the second device 2000, and the like, and may extract a link address for downloading data that may be adequately displayed and executed on the second device 2000.

A data format of the profile image card may vary, for example, according to a type of a device, a type of an OS installed in the device, a type of application executed by the device, and the like. Also, a plurality of link addresses may be related to one profile image card, and a plurality of pieces of data that have different formats may be provided through the plurality of link addresses. For example, there may be a link address A and a link address B that may both be used to download a profile image card A. The second device 2000 may download data of the profile image card A having a data format adequate for a first OS using the link address A. Also, the second device 2000 may download data of the profile image card A having a data format adequate for a second OS using the link address B.

In operation S530, the first device 1000 transmits to the second device 2000 the extracted link information while communicating with the second device 2000. For example, the first device 1000 may attempt to call the second device 2000, and the first device 1000 may transmit to the second device 2000 caller information of the first device 1000 and the extracted link information. As another example, the first device 1000 may transmit messages to the second device 2000, and may also transmit extracted link information along with a first message among the messages that are transmitted to the second device 2000.

The second device 2000 may download a profile image card of the first user using the transmitted link information, and may display the profile image card of the first user on a screen of the second device 2000.

In this example, the first device 1000 provides the link information of the profile image card of the first user to the second device 2000, and the second device 2000 downloads the profile image card of the first user from the server 3000 using the link information. However, the exemplary embodiments are not limited thereto. As another example, the first device 1000 may directly transmit the profile image card of the first user to the second device 2000. As another example, the first device 1000 and the second device 2000 may establish or otherwise setup a separate network, and the first device 1000 may transmit the profile image card of the first user to the second device 2000 via the established network. For example, after the first device 1000 sends a call request to the second device 2000 via a first network, the first device 1000 may establish a second network with the second device 2000, and may transmit the profile image card of the first user to the second device 2000 through the established second network.

FIG. 6 is a flowchart illustrating a method of sharing a profile image card in a profile image sharing system, according to an exemplary embodiment.

Referring to FIG. 6, in operation S600, the first device 1000 extracts link information about a profile image card that is matched with the second device 2000. In response to beginning communication with the second device 2000, the first device 1000 may extract the link information about the profile image card of a user that is matched with the second device 2000. For example, a user of the first device 1000 may select a second user from a phone book or digital phone list to call the second device 2000, and the first device 1000 may extract the link information about the profile image card that is matched with the selected second user.

In operation S610, the first device 1000 sends a communication request to the second device 2000 via a first network. For example, the first device 1000 may transmit a call signal to the second device 2000 via a telephone network. The telephone network may include, but is not limited to, a third generation (3G) network, a 3G long-term evolution (3G LTE) network, a fourth generation (4G) network, and the like. As another example, the first device 1000 may transmit a message to the second device 2000 via a network provided by a telecommunication company.

In operation S620, the second device 2000 activates a communication application for communication with the first device 1000. For example, the second device 2000 may receive a call signal and in response may activate a call application. As another example, the second device 2000 may receive a short message service (SMS) message or a multimedia messaging service (MMS) message from the first device 1000 and in response may activate a messaging application. As another example, the second device 2000 may receive an SMS message from the first device 1000 and in response may activate an SNS application. The communication application may be a native application of the second device 2000, however, the exemplary embodiments are not limited thereto.

In operation S630, the first device 1000 pushes the link information to the second device 2000. The link information that is pushed to the second device 2000 may be displayed on a screen of the second device 2000. In this example, operation S630 is performed after operation S610 is performed. As another example, the first device 1000 may push the link information to the second device 2000 while the first device 1000 requests to communicate with the second device 2000.

In operation S640, the second device 2000 downloads the profile image card using the communication application. The link information that is transmitted from the first device 1000 may interoperate with the communication application of the second device 2000. In this example, when the communication application of the second device 2000 receives a corresponding user input selecting the link information displayed on the screen, the communication application of the second device 2000 may access the server 3000 that provides the profile image card of the first user using the link information. As another example, the communication application of the second device 2000 may download the profile image card of the first user from the server 3000.

In operation S650, the second device 2000 displays the downloaded profile image card of the first user on an execution screen corresponding to the communication application. Also, the second device 2000 may register the downloaded profile image card of the first user in the second device 2000. For example, the second device 2000 may register the downloaded profile image card of the first user in a phone book or phone list stored by the second device 2000.

When link information is later received from the first device 1000, the second device 2000 may compare a profile image card of a user which corresponds to the received link information with a profile image card of a user that is registered in the phone book. As a result of the comparison, if the profile image card of the user corresponding to the received link information is different from the profile image card of the user registered in the second device 2000, the second device 2000 may re-download the profile image card using the received link information. That is, the profile image card of the user that corresponds to the received link information may be an updated profile image card of the user. Accordingly, the updated profile image card may be downloaded and saved.

As another example, if the profile image card of the user corresponding to the received link information is the same as the profile image card of the first user that is registered in the second device 2000, the second device 2000 may display the profile image card of the user that is already registered in the second device 2000.

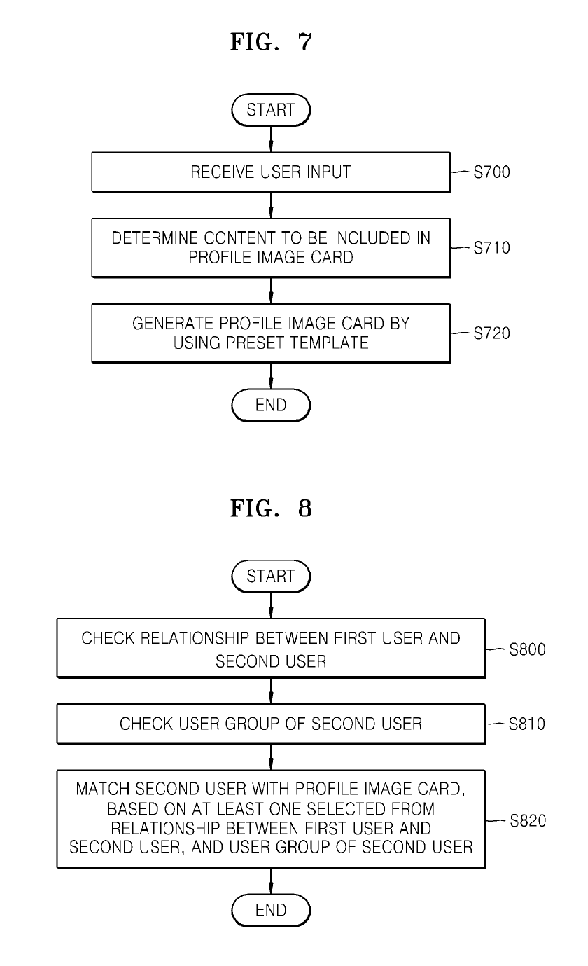

FIG. 7 is a flowchart illustrating a method of a first device generating a profile image card, according to an exemplary embodiment.

Referring to FIG. 7, in operation S700, the first device 1000 receives a user input. For example, the user input may be a request to generate a profile image card of a user. The user input may include a key input, a touch input, a motion input, a bending input, a voice input, a multimodal input, and the like. As another example, the first device 1000 may receive a user input by the user selecting a preset button. The preset button may be a button that is physically included on the first device 1000 or may be a virtual button displayed in the form of graphical user interface (GUI). For example, a user may co-select a first button (e.g., a home button) and a second button (e.g., a sound adjustment button) to input a profile image card generation request to the first device 1000.

The first device 1000 may display, on its screen, an icon corresponding to the profile image card generation request by the user. The first device 1000 may receive a user's touch input with respect to the icon.

In operation S710, the first device 1000 determines content that is to be included in the profile image card of the user. For example, in response to a user input, the first device 1000 may select an image, a motion picture, music, and the like, as a way of introducing the user for a predetermined category. The content may include, but is not limited to, a photo indicating a job of the user, a webpage of the user, a map image indicating a location of the user, and the like.

The content may be previously stored in the first device 1000 or the server 3000, but the exemplary embodiments are not limited thereto. As another example, the first device 1000 may execute a camera application and may allow the user to capture an image to be inserted into the profile image card of the user.

The first device 1000 may search for content to be included in the profile image card of the user. For example, the user may select a category of the profile image card, and the first device 1000 may search for content related to the selected category. If the user selects the category ‘Medical Doctors’, the first device 1000 may search for photos stored therein that are captured of a hospital, and the like, and at least one piece of content related to the hospital. Also, the first device 1000 may search for content related to the user-selected category among content stored in the first device 1000 and content registered in the server 3000 by the user. As another example, the first device 1000 may search for content in a search engine server, and the like.

The first device 1000 may determine a preset number of images to be included. For example, if the preset number of images is 3, the first device 1000 may determine three images that are to be included in the profile image card of the user. For example, 50 images may be found, and the first device 1000 may select three images from among the 50 images. As another example, the first device 1000 may provide a list of the found images to the user, and may receive an input by the user selecting a predetermined number of images from the image list.

In operation S720, the first device 1000 generates a profile image card of the user using a preset template. Based on preset template information, the first device 1000 may generate a profile image card of the user including content that is determined by the first device 1000 in operation S710. For example, the preset template information may include, but is not limited to, layout information, theme information, text design information, information about an effect filter that converts an image to another form, and the like.

The template may be set by the user or the first device 1000 prior to the profile image card being generated. For example, the first device 1000 or the user may generate at least one template by combining a layout, a theme, a text design, an effect filter, and the like. Also, the preset template may be changed by the user or by the first device 1000.

The first device 1000 may generate the profile image card including at least one piece of content based on the preset template. For example, the first device 1000 may include an array of images according to the layout, may add a theme image and a text design to the layout, and may apply an effect filter (e.g., a black-and-white effect filter), to generate the profile image card of the user.

Also, the first device 1000 may insert link information such as a uniform resource locator (URL) or other address related to the content into the profile image card. For example, the first device 1000 may insert preview video link information, music file link information, website link information, and the like, into the profile image card. Also, the first device 1000 may receive an input of a text related to the profile image card of the user. Accordingly, the first device 1000 may change text displayed on the profile image card of the user or may add text to the profile image card of the user based on the input text.

The first device 1000 may apply a stamp image to the profile image card of the user. For example, the first device 1000 may display a list of stamp images on an editing screen that may be used for generating the profile image card. The stamp images may be classified according to categories of profile image cards of the user. In this example, the classified stamp images may be arrayed in a list according to a preset standard. In response to a user touching a stamp image and moving the touched stamp image on the profile image card, the first device 1000 may add the touched stamp image to the profile image card.

The stamp image may further include information about a user's mood, a user's interests, a user's profile, a user's location, a link address for using a user service, and the like. Also, a tag that indicates a category of the profile image card of the user may be added to the stamp image. For example, the tag may be used by the server 3000 and the first device 1000 to identify the category of the profile image card of the user.

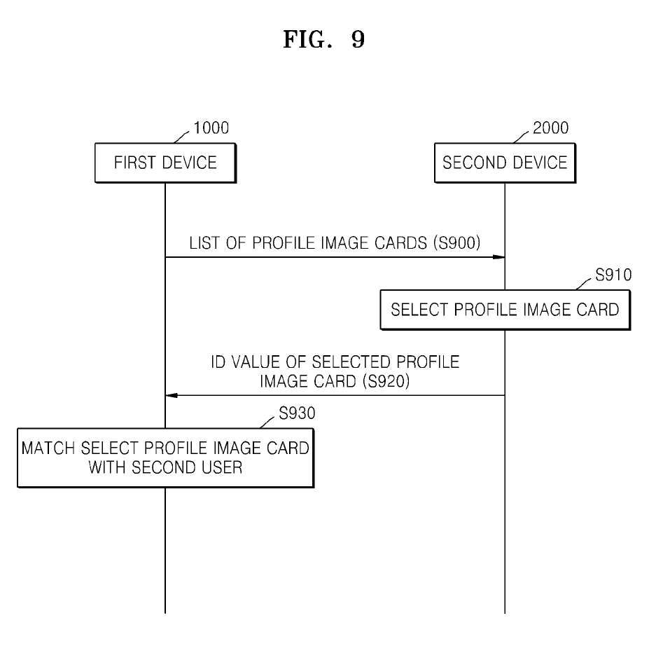

FIG. 8 is a flowchart illustrating a method of a first device for matching a profile image card of a first user with a second user, according to an exemplary embodiment.

Referring to FIG. 8, in operation S800, the first device 1000 checks a relationship between the first user and the second user. For example, the first device 1000 may obtain relationship information of the first user from an SNS server indicating an SNS that the first user joined using an SNS ID of the first user. Also, the first device 1000 may check the relationship between the first user and the second user using relationship information of the first user and an SNS ID of the second user.

However, the exemplary embodiments are not limited thereto. For example, the first device 1000 may obtain relationship information of the second user from an SNS server by identifying an SNS that the second user joined using the SNS ID of the second user, and may check a relationship between the first user and the second user using the SNS ID of the first user and the relationship information of the second user.

In operation S810, the first device 1000 checks a user group of the second user. The first device 1000 may check the user group of the second user in a phone book that is stored in the first device 1000. For example, the first device 1000 may extract user information about the second user from the phone book, and may check the user group of the second user by referring to the extracted user information. The user group may include, but is not limited to, a friend, a family member, a work colleague, and the like.

As another example, the first device 1000 may check the user group of the second user via a phone book of the first user that is stored in the server 3000. In this example, the server 3000 may store the phone book of the first user, and may update one or more pieces of user information that are stored in the phone book of the first user.

In operation S820, the first device 1000 matches the second user with the profile image card of the first user based on at least one of a relationship between the first user and the second user, the user group of the second user, and the like. As one example, the first device 1000 may match a profile image card of the first user that has a category that indicates ‘Medical Doctors’ with users that are work colleagues with the first user. As another example, the first device 1000 may match a profile image card of the first user that has a category that indicates ‘Climbers’ with users that are friends of the first user in this respect.

Accordingly, the first device 1000 may match the profile image card of the first user that has a category that indicates ‘Medical Doctors’ with users that are included in a user group ‘work colleagues.’ Also, the first device 1000 may match the profile image card of the first user that has a category that indicates ‘Climbers’ with users that are included in a user group ‘friends.’

In this case, profile image cards of the first user may be preset according to a relationship between the first user and the second user, and the user group of the second user.

The first device 1000 may match a profile image card of the first user with the second user based on a user input. For example, the first device 1000 may display the relationship between the first user and the second user, and the user group of the second user on a screen of the first device 1000. If the first user selects the second user from a user list of a phone book of the first device 1000, the first device 1000 may display the user group of the second user, and a relationship between the first user and the second user. The first user may check the user group of the second user and the relationship between the first user and the second user, and the first device 1000 may receive a user input for matching a profile image card of the first user with the second user.

As an example, if the first user and the second user are each individuals, the first device 1000 may match a profile image card of the first user indicating a job, a mood, and a hobby of the first user, and a profile image card of the first user indicating the first user's favorite content, with the second user. As another example, if the first user is an individual while the second user is a company, the first device 1000 may match a profile image card of the first user for finding a job, for entering a company event, and for suggesting a first user's opinion with the second user. As another example, if the first user is a company and the second user is an individual, the first device 1000 may match a profile image card of the first user for an advertisement by the company, for providing a coupon from the company, and for notifying the second user of a promotion provided by the company, with the second user. As another example, if the first user and the second user are both companies, the first device 1000 may match a profile image card of the first user for introducing the first user and a profile image card of the first user for business coordination with the second user.

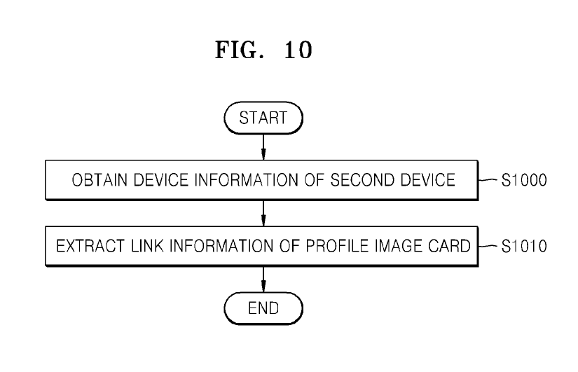

FIG. 9 is a flowchart illustrating a method of a first device for matching a profile image card of the first user with a second user in consideration of an idea of the second user, according to an exemplary embodiment of the present invention.

Referring to FIG. 9, in operation S900, the first device 1000 transmits a list of profile image cards of the first user to the second device 2000. That is, if the first device 1000 does not have a profile image card of the first user that is matched with the second user, the first device 1000 may transmit the list of profile image cards of the first user to the second device 2000. As another example, if the first device 1000 transmits a communication request to the second device 2000, the first device 1000 may push the list of profile image cards of the first user to the second device 2000. For example, the first device 1000 may call the second device 2000, and the first device 1000 may provide both caller information and the list of profile image cards of the first user.

In operation S910, the second device 2000 selects a profile image card of the first user from the list of profile image cards. For example, the second device 2000 may select the profile image card based on a selection that is input from the second user.

In operation S920, the second device 2000 transmits an ID value of the selected profile image card of the first user to the first device 1000 while the second device 2000 responds to the communication request from the first device 1000.

In operation S930, the first device 1000 matches the profile image card of the first user, which is selected by the second user, with the second user. In addition, the first device 1000 may provide link information of the selected profile image card of the first user to the second device 2000.

Subsequently, when the first device 1000 communicates with the second device 2000, the first device 1000 may not perform operations S900 through S930, but instead may provide the profile image card of the first user matched with the second user to the second device 2000.

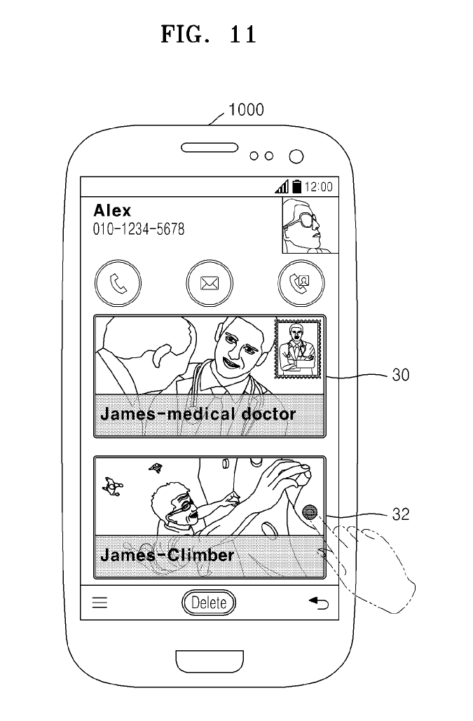

FIG. 10 is a flowchart illustrating a method of a first device for extracting link information of a profile image card of the first user, according to an exemplary embodiment.

Referring to FIG. 10, in operation S1000, the first device 1000 obtains device information of the second device 2000. The first device 1000 may obtain the device information of the second device 2000 from the second device 2000 or from the server 3000. For example, the device information of the second device 2000 may include a name of the second device 2000, a model name of the second device 2000, a type of an OS of the second device 2000, a type of a communication application executed by the second device 2000, information about a performance of the second device 2000, information about an owner or user of the second device 2000, and the like.

In operation S1010, the first device 1000 extracts link information of a profile image card, based on the device information. The link information may include an address for downloading the profile image card of the first user. The profile image card of the first user may be related to one or to a plurality of link addresses, and various types of data may be provided through the plurality of link addresses. Based on the device information of the second device 2000, the first device 1000 may extract a link address for providing data in a format that is supported by the second device 2000.

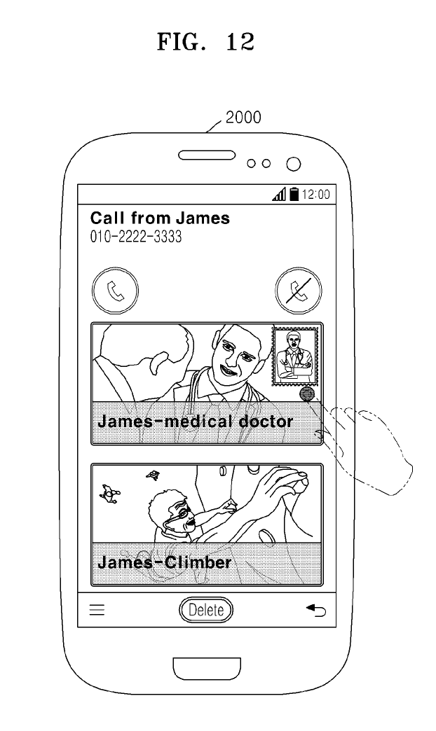

FIG. 11 is a diagram illustrating a user of the first device 1000 selecting one of his profile image cards from a screen for making a call, according to an exemplary embodiment.

As illustrated in FIG. 11, when the first user of the first device 1000 selects a second user (in this case Alex) from a user list of a phone book in order to call the second user, a list of profile image cards of the first user (in this case James) may be displayed. The profile image cards of the first user may include a profile image card 30 that has a category of ‘Medical Doctors’ and a profile image card 32 that has a category of ‘Climbers’.

When the first user selects the profile image card 32 from among the profile image cards 30 and 32, the first device 1000 may match the selected profile image card 32 of the first user with the second user and may send a call request to the second device 2000. When the first device 1000 sends the call request, the first device 1000 may also transmit caller information about the first device 1000 and link information of the profile image card 32 to the second device 2000. Accordingly, in addition to receiving the call request, the second device 2000 also receives a profile image card 32 that is selected by the user of the first device 1000.

In this example, the user of the first device 1000 selects one profile image card of the first user, but exemplary embodiments are not limited thereto. For example, the first device 1000 may select a plurality of profile image cards of the first user and may match the plurality of profile image cards of the first user to the second user.

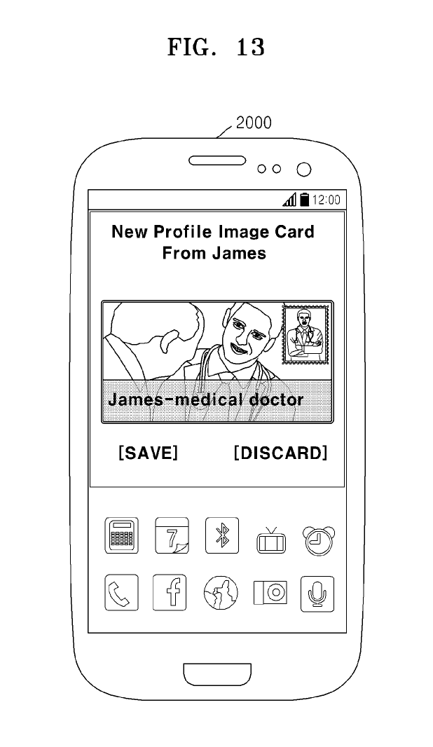

FIG. 12 is a diagram illustrating a second user of the second device 2000 selecting a profile image card of the first user, according to an exemplary embodiment.

Referring to FIG. 12, when the second device 2000 receives a call request from the first device 1000, the second device 2000 may also receive a list of profile image cards of the first user from the first device 1000. The second device 2000 may display the list of profile image cards of the first user on a screen and the second user may determine whether to accept the call request from the first device 1000. For example, the list of profile image cards of the first user may include at least one of a text, an image, and a motion picture.

The a user of the second device 2000 may select a profile image card of the first user from the list of profile image cards based on a user input, and may transmit an ID value of the selected profile image card of the first user to the first device 1000. Accordingly, the first device 1000 may match the profile image card of the first user that is selected by the second user of the second device 2000 with the second user.

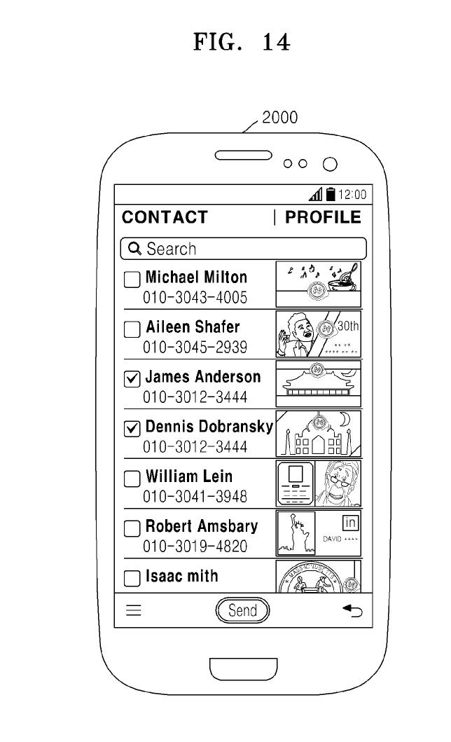

FIG. 13 is a diagram illustrating the second device 2000 receiving update information about a profile image card of the first user, according to an exemplary embodiment.

Referring to FIG. 13, the first device 1000 may update the profile image card of the first user, and may push update information about the updated profile image card of the first user to the second device 2000. In response, the second device 2000 may display the update information about the updated profile image card of the first user on a screen of the second device 2000.

As another example, the second device 2000 may download the updated profile image card of the first user based on a user selection, and may register the updated profile image card of the first user in the second device 2000.

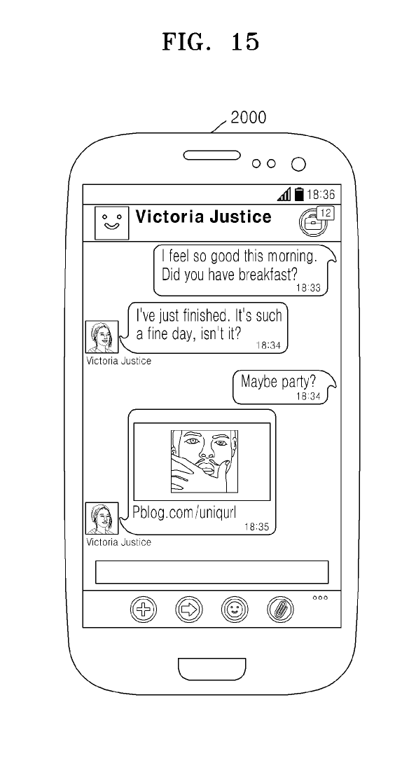

FIG. 14 is a diagram illustrating a profile image card of a plurality of users that are displayed on a contact list of the second device 2000, according to an exemplary embodiment.

Referring to FIG. 14, the contact list of the second device 2000 includes names of users and registered profile image cards of the users. For example, to communicate with another user, the second user may check a profile image card of the other user in the contact list displayed on the second device 2000, and may select the other user.

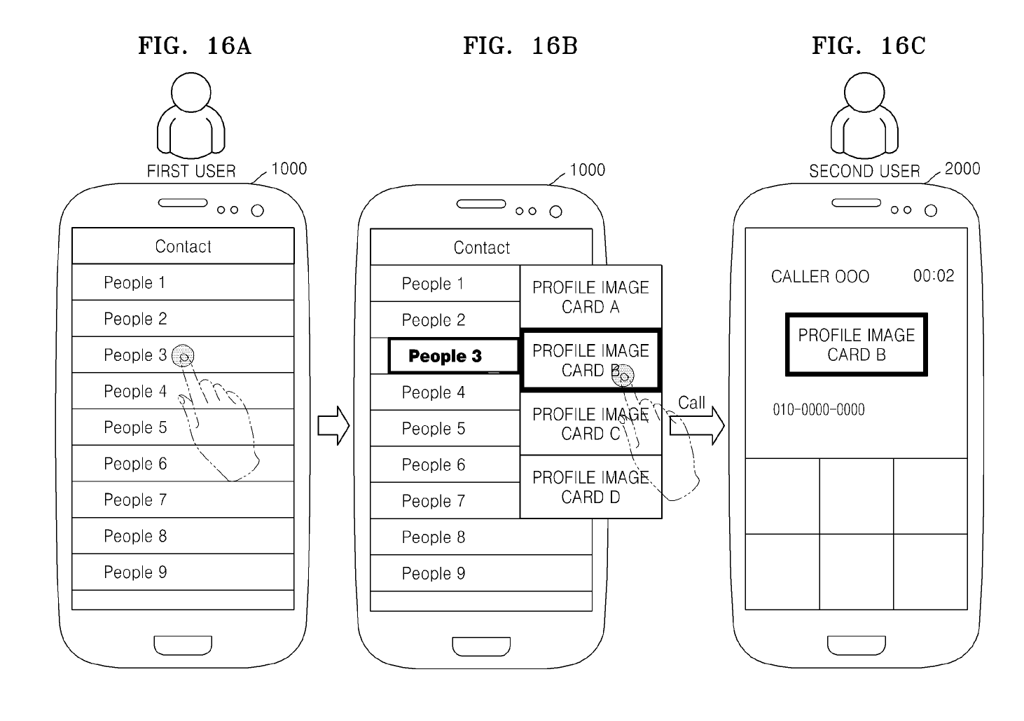

FIG. 15 is a diagram illustrating a profile image card of a user that is displayed on an execution screen of a messaging application of the second device 2000, according to an exemplary embodiment.

Referring to FIG. 15, the second device 2000 exchanges messages with the first device 1000 using a messaging application. For example, the second device 2000 may receive link information of a profile image card of a first user from the first device 1000, and may download the profile image card of the first user using the link information. In this case, the link information of the profile image card of the first user may be a link address for downloading data in a format that is capable of being displayed on the second device 2000.

Also, a user of the second device 2000 may select the link information and thus may display the profile image card of the first user on an execution screen corresponding to the messaging application.

For example, even if an OS of the first device 1000 and an OS of the second device 2000 are different from each other, or if a type of a messaging application of the first device 1000 and a type of a messaging application of the second device 2000 are different from each other, the second device 2000 may efficiently obtain and display the profile image card of the first user using a URL link or the like.

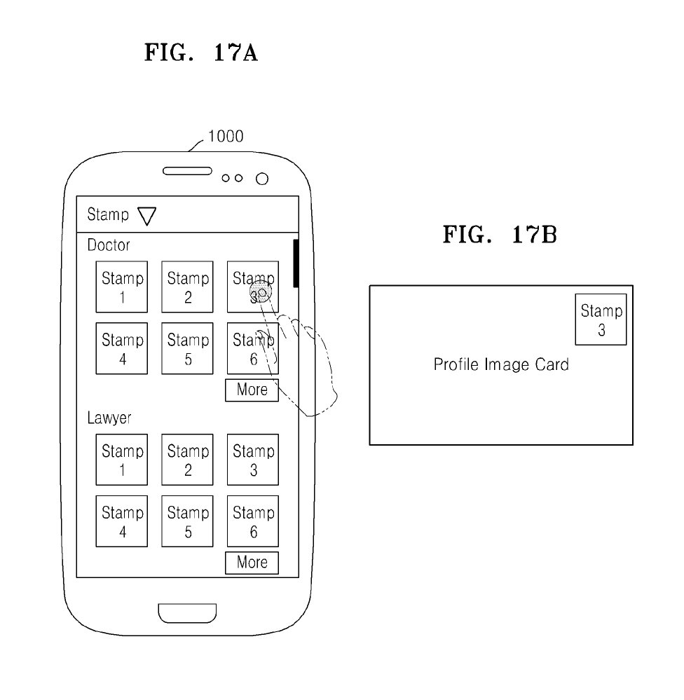

FIGS. 16A through 16C are diagrams illustrating the first device 1000 calling the second device 2000, according to exemplary embodiments.

Referring to FIG. 16A, a first user may call a second user by selecting the second user (in this case People 3) from a user list of a phone book that is displayed on a screen of the first device 1000.

Also, when the second user is selected from the user list of the phone book, as illustrated in FIG. 16B, the first device 1000 may display a list of profile image cards that are matched with the second user such as in a pop-up window. In this example, the list of profile image cards include a profile image card A, a profile image card B, a profile image card C, and a profile image card D. The first user may select the profile image card B.

In response, the first device 1000 may transmit a call signal to the second device 2000. In this case, the first device 1000 transmits caller information to the second device 2000 including a name of the first user, a telephone number of the first device 1000, link information of the profile image card B, and the like.

Referring to FIG. 16C, the second device 2000 downloads the profile image card B using the received link information of the profile image card B, and displays the profile image card on a screen of the second device 2000.

As shown in FIGS. 16A and 16B, the second user may recognize that the first user is calling by referring to the caller information that is displayed on the second device 2000, and may select a profile image card of the second user that is to be provided to the first device 1000 of the first user. The second device 2000 may also transmit link information of the selected profile image card of the second user to the first device 1000. Accordingly, the first device 1000 may receive the profile image card of the second user from the server 3000 using the link information from the second device 2000. In response, the first device 1000 may display the profile image card of the second user on the screen of the first device 1000.

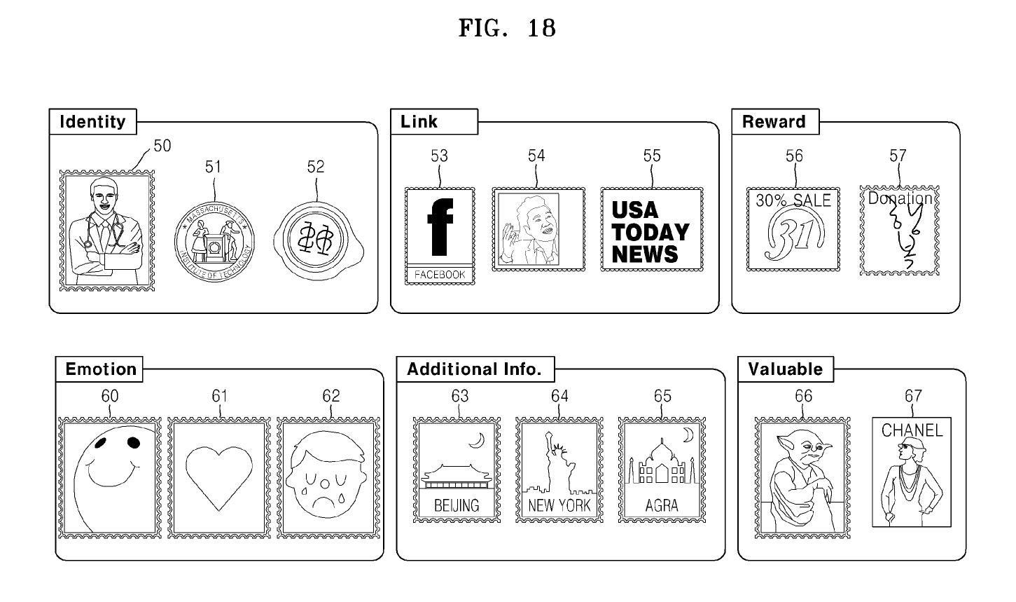

FIGS. 17A and 17B are diagrams illustrating a stamp image that is applied to a profile image card, according to exemplary embodiments.

Referring to FIG. 17A, a list of stamp images is displayed on a screen of the first device 1000. For example, the stamp images may be previously generated according to categories of a profile image card, and may be arrayed according to the categories in the list. A user may select a predetermined stamp image from the list of the stamp images, and as illustrated in FIG. 17B, may apply the predetermined stamp image to the profile image card.

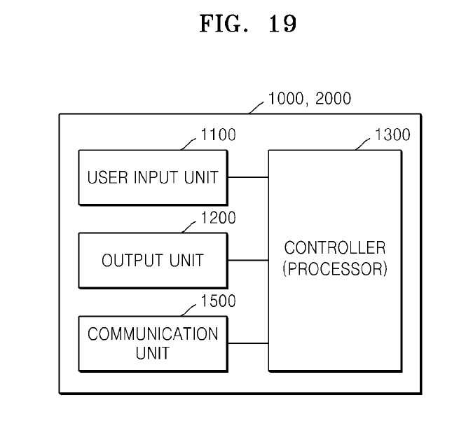

FIG. 18 is a diagram illustrating stamp images, according to an exemplary embodiment.

Referring to FIG. 18, the stamp images are classified according to attributes of the stamp images. For example, stamp images 50, 51, and 52 indicate a profile of a user. For example, the stamp images 50, 51, and 52 may be a photo of the user, an indication of a school attended by the user, a symbol of an organization that the user belongs to, and the like.

Stamp images 53, 54, and 55 indicate services that the user provides. For example, the stamp images 53, 54, and 55 may include link addresses for using the services that the user provides. When a user selects the stamp images 53, 54, and 55 on a profile image card, the second device 2000 may access webpages using the link addresses that are attached to the stamp images 53, 54, and 55.

Stamp images 56 and 57 have economical values. For example, the stamp image 56 includes information about a discount coupon. When stamp image 56 is selected by a user, the second device 2000 may download the discount coupon. The stamp image 57 is for making a donation to an organization.

Stamp images 60, 61, and 62 express a user's emotions. For example, the stamp images 60, 61, and 62 may be applied to a profile image card and may be used to express emotions of a user of the profile image card.

Stamp images 63, 64, and 65 indicate additional information. For example, the stamp images 63, 64, and 65 may indicate a location of the first device 1000 or a user.

Stamp images 66 and 67 indicate a value of a profile image card to which the stamp images 66 and 67 are applied, or may indicate a value of an owner of the stamp images 66 and 67. For example, stamp images 66 and 67 may be provided to a user when the user purchases a predetermined item. Alternatively, the stamp images 66 and 67 may be purchased by the user. The stamp images 66 and 67 may have one or more attributes, and may be exchanged, given, and traded among users.

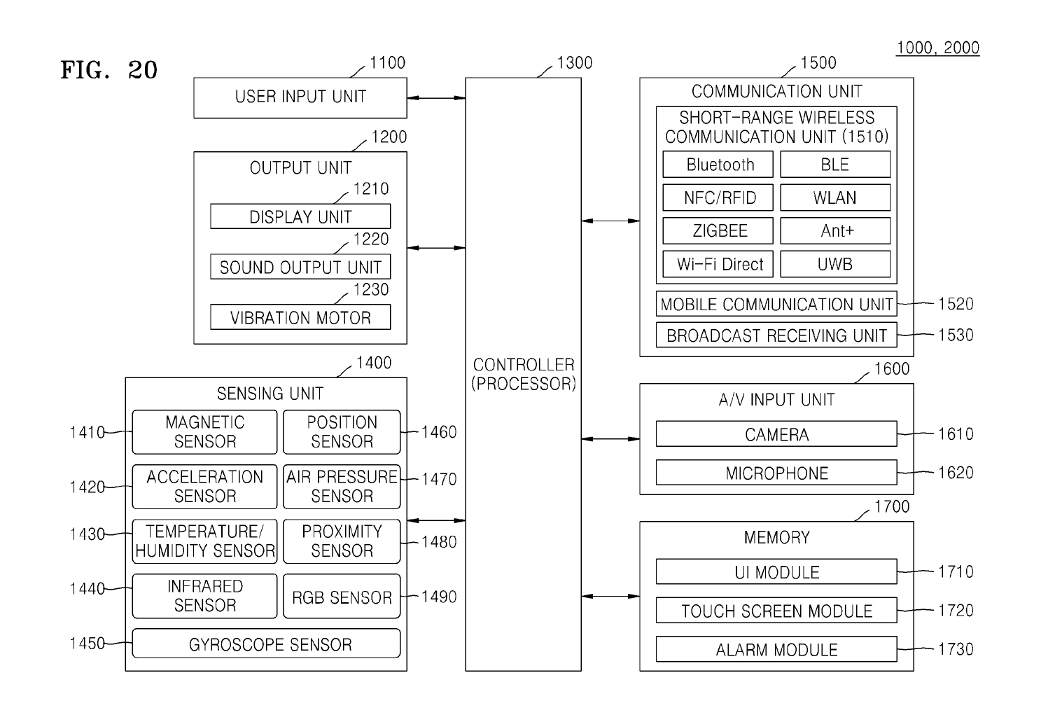

FIGS. 19 and 20 are block diagrams illustrating the first device 1000, according to exemplary embodiments. It should also be appreciated that the second device 2000 may include the same elements as the first device 1000.

Referring to FIG. 19, the first device 1000 includes a user input unit 1100, an output unit 1200, a controller 1300 (also referred as the processor 1300), and a communication unit 1500. However, one or more of the elements shown in FIG. 19 may be omitted or combined. That is, the first device 1000 may include more or less elements than the elements shown in FIG. 19.

For example, as illustrated in FIG. 20, the first device 1000 may further include a sensing unit 1400, an audio/video (A/V) input unit 1600, and a memory 1700 in addition to the user input unit 1100, the output unit 1200, the controller 1300, and the communication unit 1500.

The user input unit 1100 may be a unit used by a user to input data to control the first device 1000. For example, the user input unit 1100 may include a key pad, a dome switch, a touch pad, a jog wheel, a jog switch, and the like. For example, the touch pad may include a touch capacitive type touch pad, a pressure resistive type touch pad, an infrared beam sensing type touch pad, a surface acoustic wave type touch pad, an integral strain gauge type touch pad, a piezo effect type touch pad, and the like.

The user input unit 1100 may receive a user input. For example, the user input unit 1100 may receive a user input for generating a profile image card of a first user, for matching the profile image card of the first user with a second user, for communicating with the second device 2000, for updating the profile image card of the first user, for executing an application, for applying a stamp image to a UI object in the profile image card of the first user, and the like.

The output unit 1200 may output an audio signal, a video signal, a vibration signal, and the like, and may include a display unit 1210, a sound output unit 1220, a vibration motor 1230, and the like.

The display unit 1210 is controlled by the controller 1300 and displays information that is processed by the first device 1000. The display unit 1210 may display a user interface (UI), for example, a UI for generating the profile image card of the first user, a UI for matching the profile image card of the first user with the second user, a UI for communicating with the second device 2000, and the like.

In some examples, the display unit 1210 and a touch pad may be combined to form a touch screen. Accordingly, the display unit 1210 may be used as both an output device and an input device. The display unit 1210 may include a liquid crystal display (LCD), a thin film transistor-liquid crystal display (TFT-LCD), an organic light-emitting diode display, a flexible display, a three-dimensional (3D) display, an electrophoretic display, and the like. Also, according to a type of the first device 1000, the first device 1000 may include multiple display units 1210. Here, the plurality of display units 1210 may include two display units that face each other and which are connected using a hinge.

The sound output unit 1220 may output audio data that is received from the communication unit 1500 or that is stored in the memory 1700. For example, the sound output unit 1220 outputs a sound signal such as a call signal receiving sound, a message receiving sound, an alarm sound, and the like, related to functions of the first device 1000. The sound output unit 1220 may include a speaker, a buzzer, or the like.

The vibration motor 1230 may output a vibration signal. For example, the vibration motor 1230 may output a vibration signal that corresponds to an output of the audio data such as the call signal receiving sound, the message receiving sound, or the like, or video data. Also, when a touch is input via a touch screen, the vibration motor 1230 may output a vibration signal.

The controller 1300 may generally control the operations of the first device 1000. For example, the controller 1300 may control the user input unit 1100, the output unit 1200, the sensing unit 1400, the communication unit 1500, the A/V input unit 1600, and the like, by executing programs stored in the memory 1700. Also, the controller 1300 may control the user input unit 1100, the output unit 1200, the sensing unit 1400, the communication unit 1500, and the A/V input unit 1600, and thus, may control the first device 1000 to generate a profile image card of the first user and to match and share the profile image card with the second user.

For example, the controller 1300 may obtain a plurality of image cards of the first user. The controller 1300 may obtain the plurality of profile image cards of the first user from the memory 1700 or from the server 3000. In this case, the plurality of profile image cards of the first user may be previously stored in the memory 1700 or the server 3000.

The controller 1300 may generate the profile image cards of the first user. For example, the controller 1300 may generate the profile image cards of the first user by executing an application of the first device 1000. The executed application may correspond to a native application of the first device 1000. The controller 1300 may also generate the profile image cards of the first user based on a user inputting information through a UI that is provided by the server 3000. In order to generate the profile image cards of the first user, the controller 1300 may select a template and may determine content to be included in the profile image cards based on the selected template. Also, the controller 1300 may apply a stamp image to the profile image cards of the first user. A tag may be used to indicate a category of the profile image cards of the first user and may be attached to the stamp image. The tag attached to the stamp image may be used by the first device 1000, the second device 2000, and the server 3000, to identify a category of the profile image cards of the first user.

The controller 1300 may register the profile image card of the first user in the memory 1700 of the first device 1000 and the server 3000. If the controller 1300 generates a plurality of profile image cards of the first user, the controller 1300 may register the plurality of profile image cards in at least one of the memory 1700 of the first device 1000, and the server 3000.

The controller 1300 may match at least one of a plurality of profile image cards of the first user with the second user. For example, the controller 1300 may match a profile image card of the first user with the second user based on user information, group information, relationship information, and the like, of the second user. As an example, the controller 1300 may identify a user group of the second user, and may match the profile image card of the first user that matches the user group of the second user, with the second user. In this case, profile image cards of users may be previously matched according to user groups. The controller 1300 may obtain a SNS ID of the first user and a SNS ID of the second user, and may recognize a relationship between the first user and the second user based on the obtained SNS IDs of the first and second users. The controller 1300 may match the profile image card of the first user with the second user based on the recognized relationship between the first user and the second user.

The controller 1300 may also match a profile image card of the first user with the second user based on a user input. One or more of the user information, the group information, and the relationship information of the second user may be displayed on a screen of the first device 1000, and the first user may select one or more profile image cards from a list of profile image cards. For example, when the first user selects the second user from a phone book to call the second device 2000 corresponding to the second user, the user information, the group information, and the relationship information of the second user may be displayed on the screen of the first device 1000. In this example, the controller 1300 may select at least one of the plurality of profile image cards of the first user and may start phone communication with the second device 2000.

The controller 1300 may extract link information about the profile image card of the first user that is matched with the second user. For example, the link information about the profile image card of the first user may include a link address (e.g., a URL address) which may be used to download the profile image card of the first user. The controller 1300 may extract the link information based on an attribute of the second device 2000, and an attribute of a communication application installed in the second device 2000. For example, the first device 1000 may check an ID value of the second device 2000, a type of an OS of the second device 2000, and/or performance characteristics of the second device 2000, and may obtain the link address for downloading data that is of a format that is capable of being displayed and executed by the second device 2000.

According to various aspects, a data format of the profile image card may vary according to a type of a device, a type of an OS installed in the device, a type of an application executed in the device, and the like. Therefore, a plurality of link addresses may be related to one profile image card, and a plurality of pieces of data having different formats may be provided through the plurality of link addresses. For example, there may be a link address A and a link address B for downloading the same profile image card A. In this example, the second device 2000 may download data of the profile image card A having a data format adequate for a first OS using the link address A. Also, the second device 2000 may download data of the profile image card A having a data format adequate for a second OS using the link address B.

During communication with the second device 2000 of the second user, the controller 1300 may control the communication unit 1500 to transmit the extracted link information. For example, the controller 1300 may attempt to call the second device 2000 and may also simultaneously transmit caller information of the first device 1000 and the extracted link information to the second device 2000. As another example, the controller 1300 may transmit a message such as an instant message to the second device 2000, and may also transmit the extracted link information along with the message to the second device 2000.

The sensing unit 1400 may sense a status of the first device 1000 or a status of a surrounding area around the first device 1000, and may deliver information about the sensed statuses to the controller 1300.

For example, the sensing unit 1400 may include a magnetic sensor 1410, an acceleration sensor 1420, a temperature/humidity sensor 1430, an infrared sensor 1440, a gyroscope sensor 1450, a position sensor (e.g., GPS) 1460, an air pressure sensor 1470, a proximity sensor 1480, and an RGB sensor (i.e., a luminance sensor) 1490, but one or more embodiments are not limited thereto.

The communication unit 1500 may include one or more elements enabling the first device 1000 to communicate with the second device 2000 and the server 3000. For example, the communication unit 1500 may include a short-range wireless communication unit 1510, a mobile communication unit 1520, and a broadcast receiving unit 1530.

The short-range communication unit 1510 may include, but is not limited thereto, a Bluetooth communication unit, a Bluetooth Low Energy (BLE) communication unit, a near field wireless communication unit, a Wi-Fi communication unit, a ZigBee communication unit, an Infrared Data Association (IrDA) communication unit, a Wi-Fi Direct (WFD) communication unit, a ultra wideband (UWB) communication unit, an Ant+ communication unit, and the like.

The mobile communication unit 1520 may transmit and receive a wireless signal from a base station, an external terminal, a server, and the like, on a mobile communication network. The wireless signal may include various types of data according to communication in regard to a sound call signal, a video call signal, a text/multimedia message, and the like.

The broadcast receiving unit 1530 receives a broadcast signal and/or information related to broadcast signal from an external source through a broadcast channel. The broadcast channel may include a satellite channel and a ground wave channel. Alternatively, the first device 1000 may not include the broadcast receiving unit 1530.

The communication unit 1500 is controlled by the controller 1300 and may transmit and receive data to and from the second device 2000 and the server 3000. The communication unit 1500 may directly transmit data to the second device 2000 or may transmit data to the second device 2000 via the server 3000. Also, the communication unit 1500 may directly receive data from the second device 2000 or may receive data from the second device 2000 via the server 3000. The communication unit 1500 may exchange the profile image card of the first user with the second device 2000 and the server 3000.

The A/V input unit 1600 may receive an input of an audio signal or a video signal and may include a camera 1610 and a microphone 1620. For example, the camera 1610 may obtain an image frame such as a still image or a motion picture image via an image sensor during a video call mode or in an image-capturing mode. An image that is captured via the image sensor may be processed by the controller 1300 or a separate image processing unit.

The image frame that is processed by the camera 1610 may be stored in the memory 1700 or may be transmitted to an external source via the communication unit 1500. In some examples, the first device 1000 may include two or more cameras 1610.

The microphone 1620 receives an external sound signal as an input and processes the received sound signal into electrical voice data. For example, the microphone 1620 may receive a sound signal from an external device or a speaker. To remove noise that occurs while the sound signal is externally input, the microphone 1620 may use various noise removing algorithms.

The memory 1700 may store a program for processing and controlling the controller 1300, and a plurality of pieces of data, for example, a plurality of menus, a plurality of first hierarchical sub-menus that correspond to the plurality of menus, respectively, a plurality of second hierarchical sub-menus that correspond to the plurality of first hierarchical sub-menus, respectively, and the like, which are input to the first device 1000 or output from the first device 1000.

The memory 1700 may include a storage medium such as a flash memory, a hard disk, a multimedia card type memory, a card type memory such as an SD or XD card memory, a random access memory (RAM), a static random access memory (SRAM), a read-only memory (ROM), an electrically erasable programmable read-only memory (EEPROM), a programmable read-only memory (PROM), a magnetic memory, a magnetic disc, an optical disc, and the like. Also, the first device 1000 may run or connect to a web storage or a cloud server that performs a storage function of the memory 1700 on the Internet.

The programs stored in the memory 1700 may be classified into a plurality of modules according to their functions, for example, a UI module 1710, a touch screen module 1720, an alarm module 1730, and the like.

The UI module 1710 may provide a specialized UI or a graphical user interface (GUI) in connection with the first device 1000 for each application. For example, the touch screen module 1720 may detect a user's touch gesture on a touch screen and transmit information about the touch gesture to the controller 1300. The touch screen module 1720 may recognize and analyze a touch code. For example, the touch screen module 1720 may be configured using additional hardware including a controller.

Various sensors may be arranged on or near the touch screen to detect a touch or a proximate touch on the touch screen. An example of the sensor to detect the touch on the touch screen may include a tactile sensor. The tactile sensor detects a contact of a specific object at least as sensitively as a person can detect. The tactile sensor may also detect various types of information such as a roughness of a contact surface, a hardness of the contact object, a temperature of a contact point, and the like.

An example of the sensor to detect the touch on the touch screen may include a proximity sensor. For example, the proximity sensor may detect the presence of an object that approaches a predetermined detection surface or that is present nearby using a force of an electro-magnetic field or an infrared ray, instead of a mechanical contact. Examples of the proximity sensor include a transmission-type photoelectric sensor, a direction reflection-type photoelectric sensor, a mirror reflection-type photoelectric sensor, a high frequency oscillation-type proximity sensor, a capacity-type proximity sensor, a magnetic proximity sensor, an infrared-type proximity sensor, and the like. Examples of the touch gesture (i.e., an input) of the user may include a tap gesture, a touch and hold gesture, a double tap gesture, a drag gesture, a panning gesture, a flick gesture, a drag and drop gesture, a swipe gesture, and the like.

The alarm module 1730 may generate a signal informing the first user of the occurrence of an event. Examples of the event that occurs in the first device 1000 may include a call signal reception, a message reception, a key signal input, schedule notification, and the like. The alarm module 1730 may output a video-format alarm signal via the display unit 1210, an audio-format alarm signal via the sound output unit 1220, or a vibration signal via the vibration motor 1230.

It should be appreciated that the second device 2000 may have same elements as shown in the examples of the first device 1000 in FIGS. 19 and 20. Hereinafter, an example of the second device 2000 is described below with reference to FIGS. 19 and 20.

For example, the user input unit 1100 may receive a user input for communicating with the first device 1000, or a user input selecting at least one of a plurality of profile image cards of the first user.

The output unit 1200 may be controlled by the controller 1300 and may output information processed by the second device 2000. The communication unit 1500 may also be controlled by the controller 1300 and may exchange data with the first device 1000 and the server 3000.

In response to receiving a communication request from the first device 1000, the controller 1300 may activate an application for communicating with the first device 1000, and may display, on the output unit 1200, link information that is received from the first device 1000. Also, the controller 1300 may download a profile image card of the first user from the server 3000 based on the link information, and may display the profile image card of the first user on the output unit 1200. The controller 1300 may receive a list of profile image cards of the first user from the first device 1000, select at least one profile image card of the first user, and control the at least one selected profile image card of the first user to be matched with the second user.

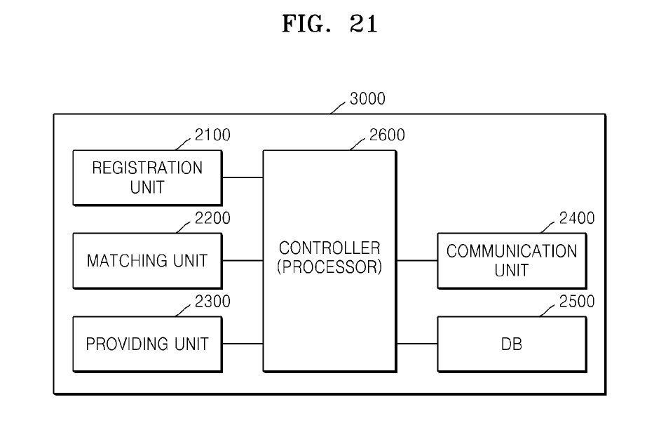

FIG. 21 is a block diagram illustrating the server 3000, according to an exemplary embodiment.

Referring to FIG. 21, the server 3000 includes a registration unit 2100, a matching unit 2200, a providing unit 2300, a communication unit 2400, a database (DB) 2500, and a controller (also referred as a processor) 2600.

The registration unit 2100 obtains and registers a profile image card of a first user in the DB 2500 as described herein. The registration unit 2100 may receive the profile image card of the first user from the first device 1000 via the communication unit 2400. The first device 1000 may provide the profile image card of the first user to the server 3000 via a webpage provided by the server 3000. The first device 1000 may transmit the profile image card of the first user to the server 3000 via an application installed at the first device 1000.

The registration unit 2100 may classify profile image cards of users according to categories. For example, the registration unit 2100 may identify a category of a profile image card by referring to a category tag that may be attached to a stamp image of the profile image card. Also, the registration unit 2100 may classify the profile image cards based on the identified information about categories of the profile image cards. The categories of the profile image cards may be previously set according to a field of interest, a job, a living area, an age, a gender, an expertise of a user, and the like. Also, the category tag may include information about the field of interest, the job, the area, the age, and the gender of the user.

The profile image card of the user may be included in a plurality of main/sub categories. For example, the profile image card may be included in a main category “Medical Doctor” and a sub category “Internal Medicine Doctor”.

The matching unit 2200 matches a profile image card of the first user with a second user. The matching unit 2200 may perform the matching using matching information that is received from the first device 1000. As another example, the matching unit 2200 may match the profile image card of the first user with the second user according to a preset reference. As another example, the matching unit 2200 may match the profile image card of the first user with the second user using matching information that is received from the second device 2000. The matching information may indicate which user is matched with the profile image card of the first user.

The providing unit 2300 provides to the second device 2000 a profile image card of the first user that is matched with the second user. For example, the second device 2000 may request the profile image card of the first user from the server 3000 using link information that is received from the first device 1000. In response to the request from the second device 2000, the providing unit 2300 may transmit to the second device 2000 the profile image card of the first user matched with the second user. As another example, the providing unit 2300 may recommend a profile image card of a user to the second device 2000 according to a preset reference.

The communication unit 2400 may exchange data for sharing a profile image card of users with the first device 1000 and the second device 2000. For example, the communication unit 2400 may exchange the profile image card and matching information with the first device 1000 and the second device 2000.

The DB 2500 stores information for sharing the profile image card. For example, the DB 2500 may store the profile image card and the matching information.

The controller 2600 generally controls the operations of the server 3000. The controller 2600 controls the registration unit 2100, the matching unit 2200, the providing unit 2300, the communication unit 2400, and the DB 2500 to control the server 3000 to share a profile image card with an external device.

The one or more exemplary embodiments and methods described herein may be embodied as computer readable code/instructions on a recording medium, e.g., a program module to be executed in computers, the program module including computer-readable commands. The computer storage medium may include any usable medium that may be accessed by computers, volatile and non-volatile medium, and detachable and non-detachable medium. Also, the computer storage medium may include a computer storage medium and a communication medium. The computer storage medium includes all volatile and non-volatile media, and detachable and non-detachable media which are technically implemented to store information including computer readable commands, data structures, program modules or other data. The communication medium stores computer-readable commands, data structures, program modules, other data as modulation-type data signals such as carrier signals, or other transmission mechanisms, and may include other information transmission mediums.

It should be understood that the exemplary embodiments described herein should be considered in a descriptive sense only and not for purposes of limitation. Descriptions of features or aspects within each embodiment should typically be considered as available for other similar features or aspects in other embodiments. For example, configuring elements that are singular forms may be executed in a distributed fashion, and also, configuring elements that are distributed may be combined and then executed.

While exemplary embodiments have been particularly shown and described, it will be understood by those of ordinary skill in the art that various changes in form and details may be made therein without departing from the spirit and scope of the inventive concept as defined by the following claims.

What is claimed is:

1. A method of a first device for sharing a profile image card, the method comprising:
obtaining a plurality of profile image cards of a first user of the first device;
matching at least one profile image card of the first user from among the plurality of profile image cards with a second user of a second device;
extracting link information about the at least one matched profile image card; and
requesting to communicate with the second device and transmitting the link information about the at least one matched profile image card to the second device.

2. The method of claim 1, wherein the link information is pushed to the second device in response to the first device beginning communication with the second device.

3. The method of claim 1, wherein the at least one profile image card of the first user is matched with the second user based on at least one of a user group of the second user and a relationship between the first user and the second user.

4. The method of claim 1, wherein the at least one profile image card of the first user is matched with the second user based on user information stored in a phone book of the first device.

5. The method of claim 1, wherein the at least one profile image card of the first user is matched with the second user based on relationship information of the first user on a social network service (SNS).

6. The method of claim 1, wherein the extracting comprises extracting the link information based on at least one of an identification (ID) value of the second device, a type of an operating system (OS) of the second device, a type of communication application executed by the second device, and a performance of the second device.

7. The method of claim 1, wherein the link information comprises a link address for downloading data of the at least one matched profile image card of the first user.

8. The method of claim 1, further comprising, in response to the at least one matched profile image card of the first user being changed, pushing link information of a changed matched profile image card of the first user to the second device of the second user.

9. The method of claim 1, wherein the at least one matched profile image card of the first user is downloaded to the second device via another network that is different from a network for the communication.

10. The method of claim 1, wherein the communication comprises at least one of a phone communication and a message communication.

11. The method of claim 1, wherein the plurality of profile image cards of the first user are generated by the first user according to a plurality of categories.

12. The method of claim 1, wherein the matching further comprises:
providing a list of the plurality of profile image cards of the first user to the second device of the second user;
receiving, from the second device, an ID value of a profile image card of the first user selected from the list by the second user; and
matching the profile image card of the first user having the ID value with the second user.

13. The method of claim 1, wherein the link information interoperates with a communication application that is executed by the second device, and the at least one matched profile image card of the first user is displayed on a screen of the second device via the communication application.

14. A first device that shares a profile image card of a first user, the first device comprising:
a controller configured to obtain a plurality of profile image cards of the first user of the first device, match at least one profile image card of the first user among the plurality of profile image cards with a second user of a second device, and extract link information about the at least one matched profile image card of the first user; and
a communicator configured to request to communicate with the second device of the second user, and transmit the link information about the at least one matched profile image card to the second device.

15. The first device of claim 14, wherein the controller is configured to push the link information to the second device in response to the first device beginning communication with the second device.

16. The first device of claim 14, wherein the controller is configured to match the at least one profile image card of the first user with the second user based on at least one of a user group of the second user and a relationship between the first user and the second user.

17. The first device of claim 14, wherein the controller is configured to match the at least one profile image card of the first user with the second user based on user information stored in a phone book of the first device.

18. The first device of claim 14, wherein the controller is configured to match the at least one profile image card of the first user with the second user based on relationship information of the first user on a social network service (SNS).

19. The first device of claim 14, wherein the controller is configured to extract the link information based on at least one of an identification (ID) value of the second device, a type of an operating system (OS) of the second device, a type of the communication application executed by the second device, and a performance of the second device.

20. The first device of claim 14, wherein the link information comprises a link address for downloading data of the at least one matched profile image card of the first user.

21. The first device of claim 14, wherein, in response to the at least one matched profile image card being changed, the controller is configured to push link information of the changed matched profile image card of the first user to the second device of the second user.

22. The first device of claim 14, wherein the at least one matched profile image card of the first user is downloaded to the second device via another network that is different from a network for the communication.

23. The first device of claim 14, wherein the communication comprises at least one of a phone communication and a message communication.

24. The first device of claim 14, wherein the plurality of profile image cards of the first user are generated by the first user according to a plurality of categories.

25. The first device of claim 14, wherein the controller is configured to provide a list of the plurality of profile image cards of the first user to the second device of the second user, receive from the second device an ID value of a profile image card of the first user that is selected from the list by the second user, and match the profile image card of the first user having the ID value with the second user.

26. The first device of claim 14, wherein the link information interoperates with a communication application that is executed by the second device, and the at least one matched profile image card of the first user is displayed on a screen of the second device via the communication application.

27. A method of a second device for obtaining a profile image card, the method comprising:
receiving, from a first device, a request for communication and link information of a profile image card of a first user of the first device;
displaying, in response to the request, the link information using a communication application;
downloading data of the profile image card of the first user from a server based on a user input with respect to the link information; and
displaying the profile image card of the first user on an execution screen corresponding to the communication application.

28. A non-transitory computer-readable medium having recorded thereon a program that is executable by a computer to perform the method of claim 1.

29. A non-transitory computer-readable recording medium having recorded thereon a program that is executable by a computer to perform the method of claim 27.

30. An apparatus for sharing a user profile, the apparatus comprising:
a controller configured to match a profile of a user of the apparatus with a second user of a second apparatus; and
a transmitter configured to transmit a communication request and information about the matched user profile to the second apparatus.

31. The apparatus of claim 30, wherein the information about the matched user profile includes identification information of the user of the apparatus comprising at least one of an image, a video, and text about the user.

32. The apparatus of claim 30, wherein the information about the matched user profile comprises a link for the second apparatus to use to download the matched user profile from a server.

33. The apparatus of claim 30, wherein the controller is configured to obtain a plurality of user profiles of the user, and match one from among the plurality of user profiles of the user with the second user.
